(19) United States
(12) Patent Application Publication
(10) Pub. No.: US 2026/0214546 A1
(43) Pub. Date: Jul. 23, 2026

(54) SIDELINK RELAY COMMUNICATION SCHEMES IN WIRELESS COMMUNICATIONS

(71) Applicant: ZTE Corporation, Shenzhen (CN)

(72) Inventors: Mengzhen WANG, Shenzhen (CN); Lin CHEN, Shenzhen (CN); Weiqiang DU, Shenzhen (CN)

(21) Appl. No.: 19/566,842

(22) Filed: Mar. 13, 2026

Related U.S. Application Data
(63) Continuation of application No. PCT/CN2023/122178, filed on Sep. 27, 2023.

(51) Int. Cl. H04W 40/22; H04W 88/04

(52) U.S. Cl. CPC H04W 40/22; H04W 88/04

(57) ABSTRACT

A method of wireless communication is provided. The method comprises: receiving, by a user plane (CU-UP) of a central unit of a network node from a control plane (CU-CP) of the central unit, i) user equipment (UE) information that identifies a corresponding UE as a remote UE for a U2N (UE to network) relay communication, or ii) a path switch indication that instructs to switch from a first path of the network node to a second path under the network node or a different network node; and performing a subsequent operation based on the UE information or the path switch indication.

### CROSS-REFERENCE TO RELATED APPLICATION

This application is a continuation and claims priority to International Application No. PCT/CN2023/122178, filed on September 27, 2023, the disclosure of which is hereby incorporated by reference herein in its entirety.

### TECHNICAL FIELD

This document relates to systems, devices and techniques for wireless communications.

### BACKGROUND

Wireless communication technologies are moving the world toward an increasingly connected and networked society. The rapid growth of wireless communications and advances in technology has led to greater demand for capacity and connectivity. Other aspects, such as energy consumption, device cost, spectral efficiency, and latency are also important to meeting the needs of various communication scenarios. In comparison with the existing wireless networks, next generation systems and wireless communication techniques need to provide support for an increased number of users and devices, as well as support an increasingly mobile society.

### SUMMARY

Various methods and apparatus for configuring channel state information reference signals for tracking in wireless communications are provided.

In one example aspect, a method of wireless communication is disclosed. The method comprises: receiving, by a user plane (CU-UP) of a central unit of a network node from a control plane (CU-CP) of the central unit, i) user equipment (UE) information that identifies a corresponding UE as a remote UE for a U2N (UE to network) relay communication, or ii) a path switch indication that instructs to switch from a first path of the network node to a second path under the network node or a different network node; and performing a subsequent operation based on the UE information or the path switch indication.

In another example aspect, a method of wireless communication is disclosed. The method comprises: sending, by a CU-CP of a network node to a CU-UP of the network node, i) user equipment (UE) information that identifies a corresponding UE as a remote UE for a U2N (UE to network) relay communication, or ii) a path switch indication that instructs to switch from a first path of the network node to a second path under the network node or a different network node, wherein the UE information allows the CU-UP to perform a subsequent operation based on the UE information or the path switch indication.

In another example aspect, a method of wireless communication is disclosed. The method comprises: entering, by a relay UE, a connected status connected with a network node for relaying data for a remote UE, wherein the relay UE is a target relay UE selected during a path switch.

In another example aspect, a method of wireless communication is disclosed. The method comprises: receiving, by a remote UE from a network node, configuration information that includes at least one of preamble resources, preamble indices, or PRACH resources, the configuration information is allowed to be used by a relay UE to enter a connected status with the network node.

In another example aspect, a method of wireless communication is disclosed. The method comprises: receiving, by a network node from a source network node, a list of candidate relay UEs including a connection status of each candidate relay UE; and selecting, by the network node, a relay UE for a path switch among the candidate relay UEs.

In yet another example aspect, a wireless communications apparatus comprising a processor is disclosed. The processor is configured to implement methods described herein.

In another example aspect, the various techniques described herein may be embodied as processor-executable code and stored on a computer-readable program medium.

The details of one or more implementations are set forth in the accompanying drawings, and the description below. Other features will be apparent from the description and drawings, and from the claims.

### BRIEF DESCRIPTION OF THE DRAWINGS

FIG. 1 shows two example scenarios for sidelink relay communications.

FIG. 2 shows a gNB architecture of a CU (centralized unit)-DU (distributed unit) split and a separation of CU-CP (centralized unit control plane) and CU-UP (centralized unit user plane).

FIG. 3 shows an example illustrating a download (DL) packet loss for U2N relay case according to a legacy downlink data delivery status (DDDS) and packet discard mechanisms.

FIG. 4 shows an example of a flowchart illustrating a latency of inter-gNB direct-to-indirect path switching to idle/inactive target relay UE.

FIG. 5 shows an example wireless communications network based on some implementations of the disclosed technology.

FIG. 6 is a block diagram of an example of a wireless communication apparatus based on some implementations of the disclosed technology.

FIGS. 7-11 are example flowcharts of a wireless communication method based on some implementations of the disclosed technology.

### DETAILED DESCRIPTION

The disclosed technology provides implementations and examples for configuring channel state information reference signals for tracking in wireless communications.

For U2N relay communication, to achieve better user experience /system performance, downlink lossless delivery in CU-DU split and separation of CU-CP and CU-UP architecture should be considered. Furthermore, downlink lossless delivery should be considered during i2d/i2i path switch.

In general, the path switch is triggered due to the link quality of the source path is becoming worse. If the path switch procedure takes too long time, the remote UE’s service may be interrupted, i.e. when the source link breaks, the new/target link has not been established yet. To achieve better performance of service continuity, mechanisms of latency reduction for path switch to RRC_IDLE/ RRC_INACTIVE target relay UE can be considered.

With the development of wireless multimedia services, demand for high data rate and better user experience increases, leading to more stringent requirements on system capacity and coverage of cellular networks. Various application scenarios, such as close-range data sharing, local advertising, etc., have also increased the need for proximity services. The traditional base station-centric cellular networks have shown limits in providing high data rates for proximity services.

Sidelink is an adaptation of the base station-centric communication technology that allows direct communication between two devices without going through a base station. That means cars, robots and even consumer gadgets can create their own ad hoc networks without using the radio access network as an intermediary. Sidelink communication technology is suitable to meet the requirements of high data rates for proximity services and to further reduce the burden of cellular networks, reduce battery power consumption of user equipment, and improve the robustness of network infrastructure. Sidelink service can also interchangeably referred to as device-to-device (D2D) discovery and/or communication, Proximity Services (ProSe), unilateral communication, or sidelink discovery and/or communication. The interface between two UEs can be called PC5 interface.

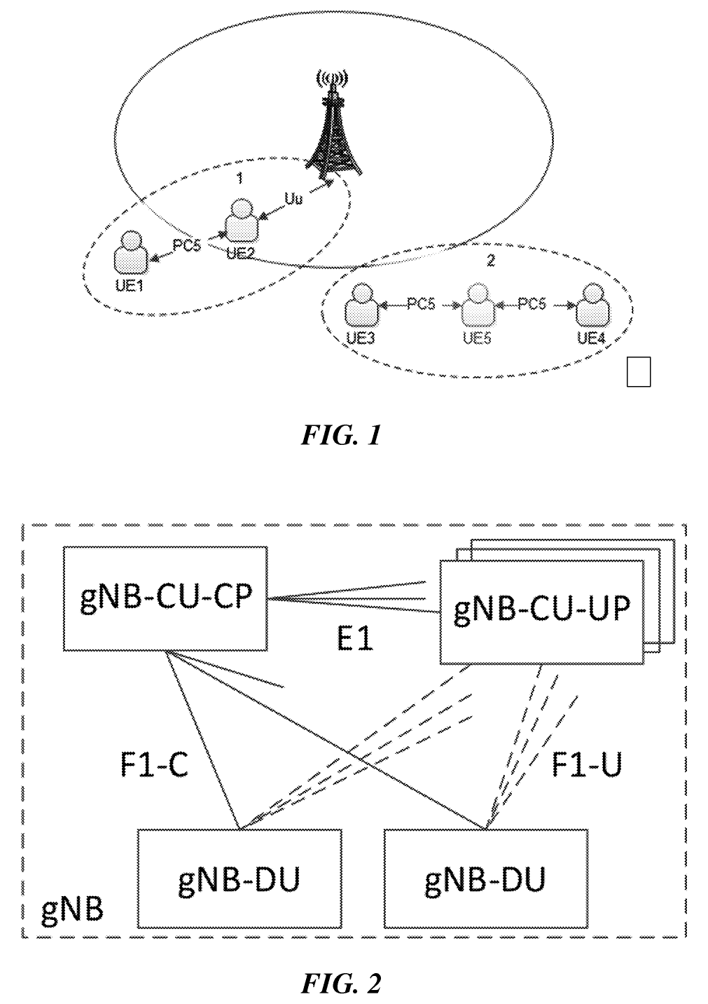

In order to support a wider range of applications and services, sidelink-based relay communication can extend coverage and improve power consumption, such as in indoor relay communication, smart agriculture, smart factories, public safety. FIG. 1 illustrates two example scenarios for sidelink relay communication.

### 1 User Equipment (UE) to Network Relay scenario

As shown in FIG. 1 (the left circle), UE 111 is in an area with poor signal quality or no coverage to communicate with the network. Sidelink communication allows UE1 to communicate with the network via UE2, thereby expanding coverage and increasing network capacity. In this scenario, UE2 can be referred to as the UE-to-Network relay device, and UE 111 can be referred as the remote UE.

### 2 UE-to-UE Relay scenario

In some cases (e.g., in the event of a catastrophe or emergency), the cellular network cannot work normally. In order to expand the coverage range of the sidelink communication, multi-hop relay using one or more UE devices can be adopted. As shown in FIG. 1 (the right circle), UE3 communicates with UE4 through UE5. Here, UE5 can be referred to as the UE-to-UE relay device, and UE3 and UE4 can be referred to as remote UEs.

For U2N relay communication, to achieve better user experience /system performance, downlink lossless delivery in CU-DU split and separation of CU-CP and CU-UP architecture should be considered. Furthermore, downlink lossless delivery should be considered during i2d/i2i path switch.

In general, the path switch is triggered due to the link quality of the source path is becoming worse. If the path switch procedure takes too long time, the remote UE’s service may be interrupted, e.g., when the source link breaks, the new/target link has not been established yet. To achieve better performance of service continuity, mechanisms of latency reduction for path switch to RRC_IDLE/ RRC_INACTIVE target relay UE can be considered.

### Example Embodiment 1: DL LOSSLESS DELIVERY for U2N RELAY in GNB SPLIT ARCHITECTURE

FIG. 2 shows the gNB architecture of the CU-DU split and the separation of CU-CP and CU-UP. According to the current mechanism, DU can send the highest sequence number of PDCP (packet data convergence protocol) PDUs successfully delivered to UE in DDDS (Downlink Data Delivery Status) to CU-UP according to Uu RLC feedback from the UE. Upon receiving the DDDS, CU-UP is allowed to remove the buffered PDCP PDUs of a RLC AM bearer according to the DDDS (the feedback of successfully delivered NR PDCP PDUs). It means the gNB may discard a packet in PDCP buffer based on Uu RLC feedback from UE. There is no critical issue for legacy Uu, since there is only one hop over Uu, and RLC feedback reflects the receiving status of the UE. However, there may be issues for U2N relay/indirect path case (a remote UE connected to network via a relay UE), because relay UE’s RLC feedback over Uu does not reflect the receiving status of remote UE.

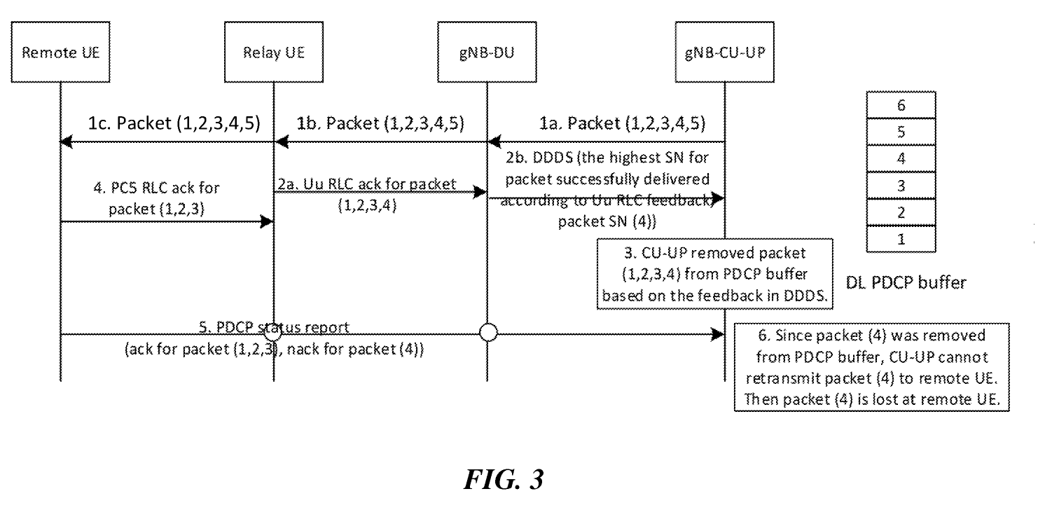

FIG. 3 shows an example for DL packet loss for U2N relay case according to the legacy DDDS and packet discard mechanisms. It is assumed that the packets 1, 2, 3, 4, 5 are sent to the remote UE through the gNB DU and the relay UE (steps 1a, 1b, 1c). In the U2N relay/indirect path scenario, the DU sends PDCP PDU delivery status / DDDS of remote UE’s downlink data to the CU-UP according to the relay UE's Uu RLC feedback (step 2a, 2b in FIG. 3) regardless of whether the packets are transmitted to remote UE over PC5 interface. The CU-UP is allowed to discard packets accordingly (step 3), e.g. discard packets 1, 2, 3, 4. However, the relay UE’s RLC confirmation does not mean that the remote UE successfully receives the DL data packets on the PC5 interface (step 4, 5). Rather, in the step 4, the remote UE sends the PC5 RLC ack for packets 1, 2, 3 and there is no ack for packet 4. If the CU-UP drops the packets of remote UE from PDCP buffer according to relay UE’s Uu RLC feedback, the packets that are confirmed by relay UE but not received by remote UE (e.g. packet 4) will be dropped from the PDCP buffer and thus cannot be re-transmitted, resulting in packet loss at remote UE (step 6).

To ensure DL packet lossless delivery for U2N relay case, the following solutions can be considered:

1) DU sends the DDDS of remote UE’s DL data to CU-UP as legacy (according to Uu RLC feedback from relay UE). If CU-UP can identify the UE as a U2N remote UE, CU-UP does not remove buffered packets from PDCP buffer according to DDDS. Instead, CU-UP may remove buffered packets from PDCP buffer according to PDCP discard timer or the PDCP status report from the remote UE. Thus, CU-UP can remove the packets successfully confirmed in the PDCP status report instead of DDDS. The PDCP discard timer s implemented and/or maintained by gNB/CU-UP implementation according to relevant specifications. The duration of the timer is configured by upper layers. The PDCP status report carries the first missing packets (“First Missing COUNT. This field indicates the COUNT value of the first missing PDCP SDU within the reordering window, i.e. RX_DELIV.”) and a bitmap indicates which packets are missing and which packets are correctly received.

In some implementations, for CU-UP to identify a UE as a U2N remote UE, CU-CP can send the UE type information (U2N remote UE, U2N relay UE, etc.) to CU-UP. In some implementations, CU-CP can forward/send authorization information (e.g., U2N remote UE authorization that indicates the UE is authorized to act as a L2 U2N remote UE) to CU-UP. CU-CP can identify the U2N remote UE based on UE type info in SidelinkUEInformation reported by the UE or authorization information from AMF over NG interface or neighbour gNB over Xn interface. By identifying the U2N remote UE, CU-UP does not remove buffered packets form PDCP buffer even when the DU sends the DDDS based on the relay UE’s Uu RLC feedback.

2) DU can identify the U2N remote UE based on UE type information (UE type in SUI carried in CU to DU RRC Information IE in F1AP message), authorization information, or indirect path configuration information (PC5 relay RLC channel/bearer mapping between end-to-end radio bearer and PC5 relay RLC channel). DU gets the UE type information from CU-CP, which is carried in CU to DU RRC information IE in F1AP message. Then, DU knows that the relay UE's RLC feedback does not mean that remote UE also receives the data. DU can delay sending of DDDS of the remote UE to CU-UP when receiving the relay UE's RLC feedback.

3) In legacy L2 U2N relay, it is hop by hop RLC over PC5 (between the remote UE and the relay UE) and over Uu (between the relay UE and the gNB). It means that the RLC feedback over PC5 and the RLC feedback over Uu are independent from each other, e.g., when successfully receiving packets from gNB, the relay UE can feedback the RLC acknowledge to the gNB without considering whether the packets are successfully delivered to the remote UE. Then, to ensure DL lossless delivery, the relay UE can delay sending Uu RLC feedback to DU, e.g. the relay UE delays sending the Uu RLC feedback when receiving the PC5 RLC feedback from the remote UE about the packets. Then, the legacy mechanisms can be applied. For example, the DU sends the DDDS of the remote UE to CU-UP according to the relay UE’s RLC feedback and CU-UP is allowed to remove DL packets from the PDCP buffer according to DDDS.

### Example Embodiment 2: DL LOSSLESS DELIVERY DURING PATH SWITCH

This embodiment addresses the DL lossless delivery during the indirect-to-indirect or indirect-to-direct path switch under the same gNB or from the source gNB to the target gNB. During inter-gNB i2d/i2i path switch, to ensure DL lossless delivery during the path switching procedure, the source gNB can proactively forward all data in PDCP buffer to target gNB. But as discussed before, if a packet that not been received by the remote UE was removed from the PDCP buffer of the source gNB, the packet will be lost nevertheless. Not to lose such packet, the pack which has not been received by the remote UE needs not to be removed from the PDCP buffer of the source gNB during the path switch. Generally, the solutions in Embodiment 1 can be reused. Besides, the following solution can be considered.

In some implementations, when CU-CP of the source gNB decides to initiate inter-gNB i2d/i2i path switch, or when CU-CP of source gNB receives the Handover request acknowledge (path switch command) message from the target gNB, CU-CP sends the path switch indication to CU-UP. The path switch indication may further include at least one of i2d path switch, i2i path switch, source indirect path. Under the direct path, the UE is connected to a cell/gNB directly. Under the indirect path, the remote UE is connected to NW via a U2N relay UE. The i2i path switch refers to the indirect to indirect path switch. Under the i2i path switch, the remote UE switches from the relay UE1 to the relay UE2 to connect to NW. Under the i2d path switch, the remote UE firstly is connected to NW via a relay UE, but after a while, the remote UE switches to a direct path (connected to NW directly). Under the d2i path switch, the remote UE is firstly connected to NW directly, and then switches to an indirect path (connected to NW via a relay UE). When receiving the indication, the CU-UP of source gNB stops removing DL packets from PDCP buffer. Thus, the CU-UP of source gNB stops removing the buffered DL packets from PDCP buffer even the successful delivery is indicated by DDDS. In addition, the CU-UP of the source gNB does not remove the buffered DL packets from PDCP buffer even the PDCP discard timer expires.

### Example Embodiment 3: LATENCY REDUCE FOR PATH SWITCHING TO RRC IDLE/INACTIVE RELAY UE - U2N

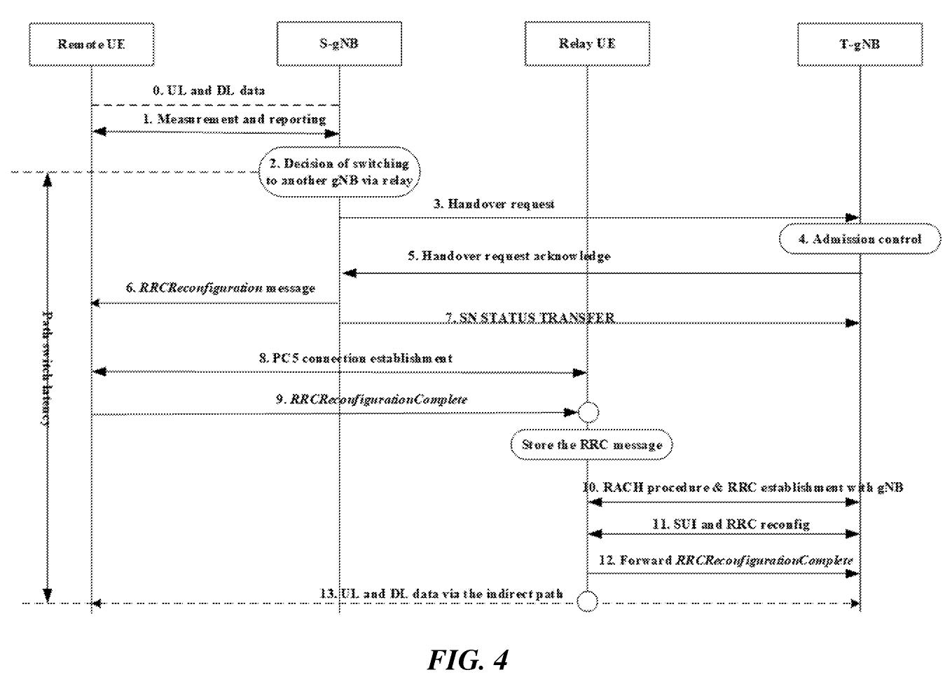

For i2i/d2i path switch, the gNB can select an L2 U2N relay UE in any RRC state e.g., RRC_IDLE, RRC_INACTIVE, or RRC_CONNECTED, as a target L2 U2N Relay UE. If a RRC_IDLE/ RRC_INACTIVE target relay UE is selected, the path switch procedure (especially, for inter-gNB case) has a long delay because of the following steps, as shown in FIG. 4 taking inter-gNB direct-to-indirect path switch as an example:

1) Exchange over Xn interface between gNBs and processing delays in gNB(s);

2) PC5-S and PC5-RRC signallings to establish PC5 unicast link/PC5-RRC connection between the remote UE and the selected target relay UE;

3) The steps to trigger the IDLE/INACTIVE target relay UE to enter RRC_CONNECTED;

4) After entering RRC_CONNECTED, signalling exchange between the target relay UE and its serving gNB to prepare the relay UE to relaying traffic for the remote UE.

In general, the path switch is triggered due to the link quality of the source path is becoming worse. If the path switch procedure takes too long time, the remote UE’s service may be interrupted, e.g., when the source link breaks, the new/target link has not been established yet. To achieve better performance of service continuity, mechanisms of latency reduction for the path switch to RRC_IDLE/ RRC_INACTIVE target relay UE can be considered.

(1) In legacy, after establishing a PC5 unicast link with the target relay UE, the remote UE sends the RRCReconfigurationComplete message via the relay UE, which triggers the relay UE to enter RRC connected state. The time to trigger the relay UE to enter RRC connected can be advanced. For example, when receiving the PC5 link establishment request message from the remote UE or when deciding to accept the request or when transmitting the PC5 link establishment response message to remote UE, the relay UE is triggered to enter RRC connected (initiate RACH procedure with the target cell). The PC5 link establishment request message may include path switch indication.

(2) Paging the selected target relay UE to enter RRC connected as soon as possible. In some implementations, if the selected target relay UE is in RRC_INACTIVE, the gNB (who selects the target relay UE) may initiate RAN paging for the target relay UE to trigger the relay UE to enter RRC connected. The paging message includes the relay UE ID. The relay UE ID may be at least one of: L2 ID, I-RNTI. If the selected target relay UE is in RRC_IDLE, the gNB may send request message to core network/AMF to request the core network to initiate CN paging for the relay UE. The request message may include at least one of: paging indication, L2 ID of the relay UE, 5G-S-TMSI of the relay UE. For intra-gNB case, the remote UE can report the RRC state of each candidate relay UE to gNB so that the gNB is definitely clear about the RRC state of the selected target relay UE. For inter-gNB case, the source gNB sends a list of candidate relay UEs to the target gNB and the target gNB finally selects the target relay UE. When sending the list of candidate relay UEs to target gNB, the RRC state of each candidate relay UE can be also included in the XnAP messages.

(3) When gNB selects a RRC idle/inactive target relay UE, gNB includes at least one of the preamble resources, preamble indices, or PRACH resources that is for relay UE performing non-contention/contention-free random access in the RRC reconfiguration to the remote UE. Then, the remote UE sends the info (preamble resources/preamble inices/PRACH resources for relay UE performing non-contention/contention-free random access in the RRC reconfiguration) to the relay UE via a container in the PC5-S messages or via the PC5-RRC message. Upon receiving the info, the relay UE uses the indicated resources to perform random access with the gNB. The relay UE sends RRC connection request message together with the relay indication or the path switch indication. For example, when sending RRC connection request message to gNB, the relay UE includes the relay indication or the path switch indication. Thus, the gNB can know it is a relay UE or a target relay UE for remote UE path switching and priorities the relay UE’s RRC connection. The relay indication or path switch indication may further include the remote UE ID (L2 ID or C-RNTI or local ID).

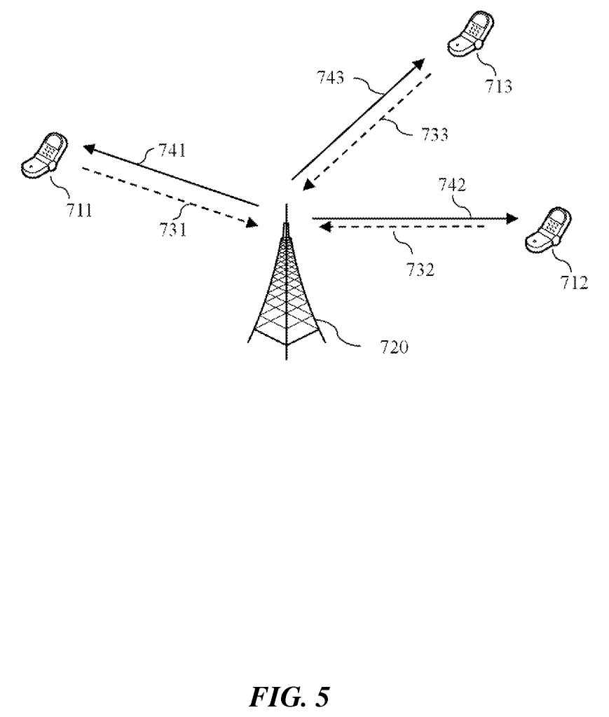

FIG. 5 shows an example of a wireless communication system (e.g., a long term evolution (LTE), 5G or NR cellular network) that includes a BS 720 and one or more user equipment (UE) 711, 712 and 713. In some embodiments, the uplink transmissions (731, 732, 733) can include uplink control information (UCI), higher layer signaling (e.g., UE assistance information or UE capability), or uplink information. In some embodiments, the downlink transmissions (741, 742, 743) can include DCI or high layer signaling or downlink information. The UE may be, for example, a smartphone, a tablet, a mobile computer, a machine to machine (M2M) device, a terminal, a mobile device, an Internet of Things (IoT) device, and so on.

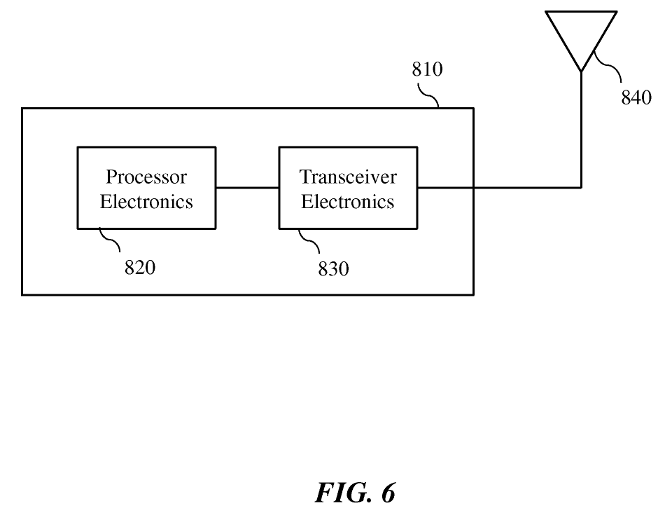

FIG. 6 is a block diagram representation of a portion of an apparatus, in accordance with some embodiments of the presently disclosed technology. An apparatus 810 such as a network device or a base station or a wireless device (or UE), can include processor electronics 820 such as a microprocessor that implements one or more of the techniques presented in this document. The apparatus 810 can include transceiver electronics 830 to send and/or receive wireless signals over one or more communication interfaces such as antenna(s) 840. The apparatus 810 can include other communication interfaces for transmitting and receiving data. Apparatus 810 can include one or more memories (not explicitly shown) configured to store information such as data and/or instructions. In some implementations, the processor electronics 820 can include at least a portion of the transceiver electronics 830. In some embodiments, at least some of the disclosed techniques, modules or functions are implemented using the apparatus 810.

Some preferred embodiments may include the following solutions.

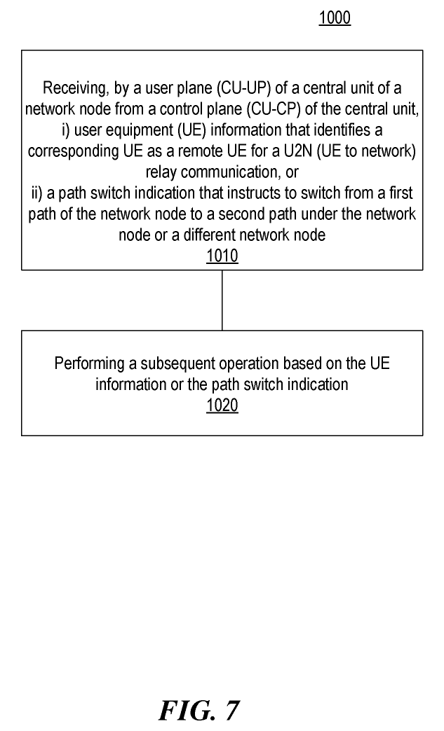

1. A method for wireless communications (e.g., method 1000 as shown in FIG. 7), comprising: receiving 1010, by a user plane (CU-UP) of a central unit of a network node from a control plane (CU-CP) of the central unit, i) user equipment (UE) information that identifies a corresponding UE as a remote UE for a U2N (UE to network) relay communication, or ii) a path switch indication that instructs to switch from a first path of the network node to a second path under the network node or a different network node; and performing 1020 a subsequent operation based on the UE information or the path switch indication.

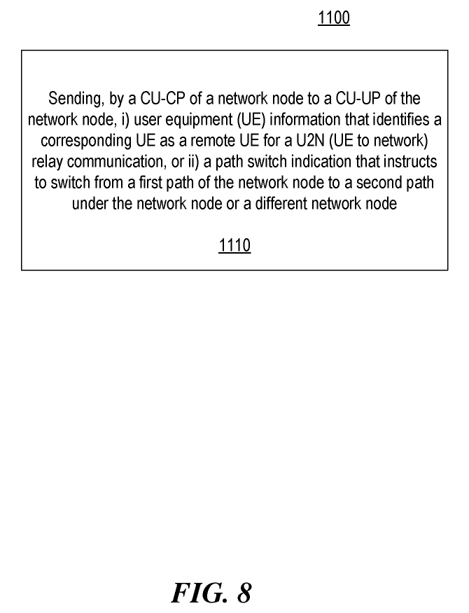

2. A method for wireless communications (e.g., method 1100 as shown in FIG. 8), comprising: sending, by a CU-CP of a network node to a CU-UP of the network node, i) user equipment (UE) information that identifies a corresponding UE as a remote UE for a U2N (UE to network) relay communication, or ii) a path switch indication that instructs to switch from a first path of the network node to a second path under the network node or a different network node, wherein the UE information or the path switch indication allows the CU-UP to perform a subsequent operation.

3. The method of solution 1 or 2, wherein the UE information includes a UE type information indicating the corresponding UE is the remote UE.

4. The method of solution 1 or 2, wherein the UE information includes an authorization information indicating that the corresponding UE is authorized to act as the remote UE.

5. The method of solution 1 or 2, wherein the path switch indication further includes at least one of an i2d path switch, an i2i path switch, or a source indirect path.

6. The method of solution 1, wherein the performing the subsequent operation includes: causing, by the CU-UP of the network node, not to remove data of a radio bearer from a buffer according to an indication in a downlink data delivery status (DDDS) of a successful delivery of the data in response to the UE information or the path switch indication.

7. The method of solution 1, wherein the performing the subsequent operation includes: stopping, by the CU-UP of the network node, removing of data of a radio bearer from a buffer in response to the UE information or the path switch indication.

8. The method of solution 7, wherein the stopping of the removing of the data from the buffer causes the CU-UP of the network node not to remove the data from the buffer in response to an indication in a downlink data delivery status (DDDS) of a successful delivery of the data or in response to an expiration of a discard timer.

9. The method of solution 2, further comprising: determining, by the CU-CP of the network node, to initiate a path switch, wherein the path switch indication is sent in response to the determining.

10. The method of solution 2, further comprising: receiving, by the CU-CP of the network node from the different network node, a message responding to a path switch request, wherein the path switch indication is sent in response to the receiving.

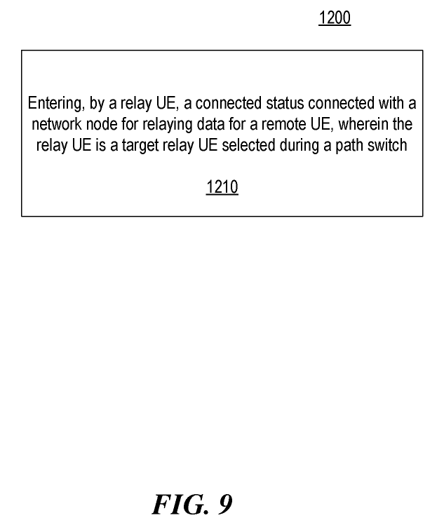

11. A method of wireless communications (e.g., method 1200 as shown in FIG. 9), comprising: entering, by a relay UE, a connected status connected with a network node for relaying data for a remote UE, wherein the relay UE is a target relay UE selected during a path switch.

12. The method of solution 11, further comprising: receiving a link establishment request message including a path switch indication from the remote UE, wherein the relay UE enters the connected status in response to the receiving the link establishment request message.

13. The method of solution 11, further comprising: receiving a link establishment request message including a path switch indication from the remote UE, and determining to accept the link establishment request message, wherein the relay UE enters the connected status in response to the determining.

14. The method of solution 11, further comprising: receiving a link establishment request message including a path switch indication from a remote UE, and sending a link establishment response message to the remote UE, wherein the relay UE enters the connected status in response to the sending the link establishment response message.

15. The method of solution 11, further comprising: receiving a paging message that pages the relay UE from the network node, wherein the relay UE enters the connected status in response to the receiving the paging message.

16. The method of solution 15, further comprising: receiving, by the network node from a source network node, a list of candidate relay UEs including a connection status of each candidate relay UE; selecting, by the network node, the relay UE for a path switch among the candidate relay UEs; and transmitting, by the network node, the paging message paging the relay UE.

17. The method of solution 11, further comprising: receiving, from the remote UE, at least one of preamble resources, preamble indices, or PRACH resources, wherein the relay UE is configured to use received resources to perform a random access with the network node.

18. The method of solution 11, further comprising: sending, by the relay UE to the network node, a relay indication or a path switch indication by included the relay indication or the path switch indication in a RRC connection request message to the network node.

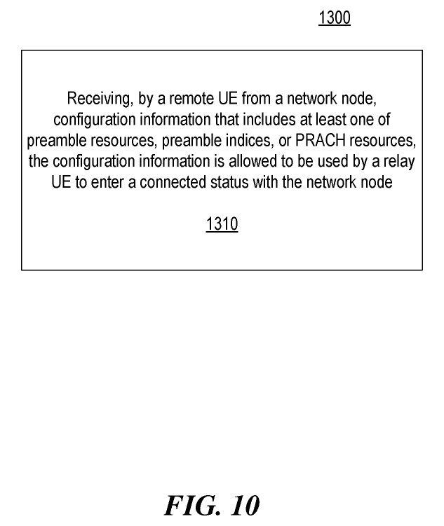

19. A method of wireless communications (e.g., method 1300 as shown in FIG. 10), comprising: receiving, by a remote UE from a network node, configuration information that includes at least one of preamble resources, preamble indices, or PRACH resources, the configuration information is allowed to be used by a relay UE to enter a connected status with the network node.

20. The method of claim 19, further comprising: sending, by the remote UE to a relay UE, the configuration information.

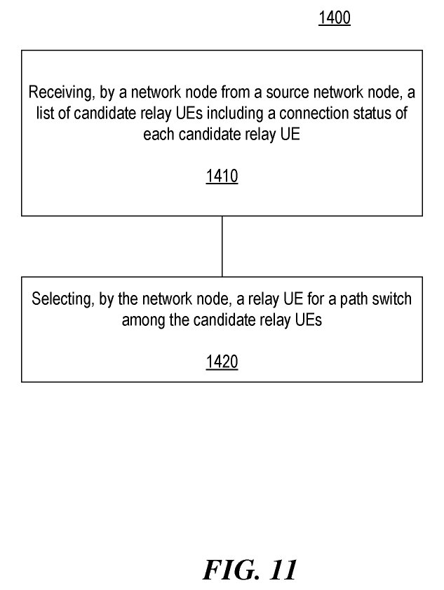

21. A method of wireless communication (e.g., method 1400 as shown in FIG. 11), comprising: receiving 1410, by a network node from a source network node, a list of candidate relay UEs including a connection status of each candidate relay UE; and selecting 1420, by the network node, a relay UE for a path switch among the candidate relay UEs.

22. The method of claim 21, further comprising: transmitting, by the network node, a paging message paging the relay UE.

23. A wireless communication apparatus comprising a processor configured to implement a method recited in any of above solutions.

24. A computer storage medium having code stored thereupon, the code, upon execution by a processor, causing the processor to implement a method recited in any of above solutions.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

1. A method for wireless communications, comprising:
receiving, by a user plane (CU-UP) of a central unit of a network node from a control plane (CU-CP) of the central unit, a path switch indication indicating that an indirect path is used for a communication with a user equipment (UE); and
performing a subsequent operation based on the path switch indication,
wherein the subsequent operation comprises not removing buffered downlink (DL) data of a radio bearer regardless of a successful delivery status indicated in a downlink data delivery status (DDDS) frame received from a distributed unit (DU).

2. The method of claim 1, further comprising:
receiving, by the CU-UP from the CU-CP, user equipment (UE) information that identifies a corresponding UE as a remote UE for a U2N (UE to network) relay communication.

3. The method of claim 2, wherein the UE information includes a UE type information indicating the corresponding UE is the remote UE, or an authorization information indicating that the corresponding UE is authorized to act as the remote UE.

4. The method of claim 1, wherein the path switch indication further indicates at least one of an indirect-to-direct (i2d) path switch, an indirect-to-indirect (i2i) path switch, or a source indirect path.

5. The method of claim 1, further comprising:
forwarding, by the CU-UP, the buffered DL data to a target network node during a path switch.

6. The method of claim 1, wherein the path switch indication indicates an inter-gNB path switch from the network node to a different network node.

7. The method of claim 1, wherein the path switch indication is received in response to the CU-CP receiving a response message to a path switch request from a different network node.

8. The method of claim 1, wherein the buffered downlink (DL) data of the radio bearer is not regardless of an expiration of a discard timer.

9. A method for wireless communications, comprising:
sending, by a control plane (CU-CP) of a network node to a user plane (CU-UP) of the network node, a path switch indication indicating that an indirect path is used for a communication with a user equipment; and
wherein the path switch indication allows the CU-UP to perform a subsequent operation,
wherein the subsequent operation comprises retaining buffered downlink (DL) data of a radio bearer regardless of a successful delivery status indicated in a downlink data delivery status (DDDS) frame received from a distributed unit (DU).

10. The method of claim 9, further comprising:
sending, by the CU-CP to the CU-UP, user equipment (UE) information that identifies a corresponding UE as a remote UE for a U2N (UE to network) relay communication.

11. The method of claim 10, wherein the UE information includes a UE type information indicating the corresponding UE is the remote UE, or an authorization information indicating that the corresponding UE is authorized to act as the remote UE.

12. The method of claim 9, wherein the path switch indication further indicates at least one of an i2d path switch, an i2i path switch, or a source indirect path.

13. The method of claim 9, further comprising:
determining, by the CU-CP of the network node, to initiate a path switch, wherein the path switch indication is sent in response to the determining.

14. The method of claim 9, further comprising:
receiving, by the CU-CP of the network node from a target network node, a message responding to a path switch request,
wherein the path switch indication is sent in response to the receiving.

15. A wireless communication apparatus comprising at least one processor and a memory, wherein the at least one processor configured to cause the wireless communication apparatus to:
receive, from a control plane (CU-CP) of a central unit of a network node, a path switch indication indicating that an indirect path is used for a communication with a user equipment (UE); and
perform a subsequent operation based on the path switch indication,
wherein the subsequent operation comprises not removing buffered downlink (DL) data of a radio bearer regardless of a successful delivery status indicated in a downlink data delivery status (DDDS) frame received from a distributed unit (DU).

16. The wireless communication apparatus of claim 15, wherein the at least one processor is further configured to cause the wireless communication apparatus to: receive, from the CU-CP, user equipment (UE) information that identifies a corresponding UE as a remote UE for a U2N (UE to network) relay communication.

17. The wireless communication apparatus of claim 15, wherein the path switch indication further indicates at least one of an indirect-to-direct (i2d) path switch, an indirect-to-indirect (i2i) path switch, or a source indirect path.

18. The wireless communication apparatus of claim 15, wherein the at least one processor is further configured to cause the wireless communication apparatus to: forward the buffered DL data to a target network node during a path switch.

19. The wireless communication apparatus of claim 15, wherein the path switch indication is received in response to the CU-CP receiving a response message to a path switch request from a different network node.

20. The wireless communication apparatus of claim 15, wherein the buffered downlink (DL) data of the radio bearer is not regardless of an expiration of a discard timer.
